(19) United States
(12) Patent Application Publication
(10) Pub. No.: US 2026/0366640 A1
(43) Pub. Date: Nov. 19, 2026

(54) VALVE CAP TOOL

(71) Applicant: David Scott DeWinter, Grand Rapids, MI (US)

(72) Inventor: David Scott DeWinter, Grand Rapids, MI (US)

(21) Appl. No.: 19/676,602

(22) Filed: May 13, 2026

Related U.S. Application Data
(60) Provisional application No. 63/835,050, filed on May 19, 2025.

(51) Int. Cl. F16K 27/08

(52) U.S. Cl. CPC F16K 27/08

(57) ABSTRACT

A valve cap tool including a tool body with a socket at one end configured to receive a valve cap, a deflectable tab disposed within the socket, and a cleat on an inner surface of the tab configured to engage a circumferential groove on the valve cap to retain it within the socket. The tab may be one of a pair of opposed tabs located along a wall of the socket, each tab of the pair carrying a respective cleat on an inner surface thereof. The valve cap tool may further include a deflator nub projecting from an exterior surface of the tool body adjacent the socket, the deflator nub configured to depress a valve core of a tire valve. The valve cap tool may also include an attached pressure gauge, and may also be embodied as an electric rotary tool.

### CROSS-REFERENCE TO RELATED APPLICATIONS

This application claims priority to U.S. Application No. 63/835,050, filed May 19, 2025, which is hereby incorporated by reference in its entirety.

### BACKGROUND

### 1. Field of the Invention

The present disclosure relates to tools for servicing pneumatic tires, and more particularly to a handheld tool configured to engage, retain, and manipulate a valve cap during removal from and replacement onto a tire valve stem.

### 2. Description of the Prior Art

Pneumatic tires are widely used on automobiles, trucks, motorcycles, bicycles, recreational vehicles, trailers, and various types of farm, construction, and industrial equipment. Such tires include an air valve that permits inflation and deflation of the tire. The air valve typically includes a spring-loaded plunger mechanism that retains pressurized air within the tire. A threaded valve cap is screwed onto the valve stem to protect the plunger mechanism from moisture, dust, dirt, road salt, and other debris that could otherwise enter the valve and cause it to malfunction.

Valve caps are prone to being lost or misplaced. Because valve caps are small, they can be easily dropped, kicked aside, or forgotten when removed from a valve stem during tire servicing. Caps that are not tightened sufficiently may loosen over time due to road vibration and eventually fall off the valve stem. In some cases, inexpensive plastic caps may crack or split and detach from the valve. The loss of a valve cap can expose the valve mechanism to contaminants that may impair its function or cause the tire to lose air pressure.

Maintaining proper tire pressure is beneficial for vehicle performance, fuel efficiency, tire longevity, and ride comfort. Drivers are generally advised to check tire pressure on a regular basis, and operators of commercial vehicles or emergency vehicles may check tire pressure daily. Checking tire pressure on vehicles with multiple axles can be time-consuming. When checking tire pressure, a user typically removes the valve cap, sets it aside, uses a pressure gauge to measure the tire pressure, and then retrieves and reinstalls the cap. This process can be inconvenient, particularly when the valve cap is difficult to access within a wheel or hubcap, or when the user is wearing gloves in cold weather. Valve caps also tend to accumulate road grime and brake dust, which can soil the user's fingers during handling.

Accordingly, there remains a desire for improved approaches to tire valve cap handling and tire pressure maintenance.

### SUMMARY

According to an aspect of the present disclosure, a valve cap tool is provided. The valve cap tool includes a tool body. A socket is defined at one end of the tool body, the socket configured to receive a valve cap therein. A deflectable tab is disposed within the socket. A cleat is disposed on an inner surface of the tab, the cleat configured to engage a circumferential groove on an exterior surface of the valve cap to retain the valve cap within the socket.

According to other aspects of the present disclosure, the valve cap tool may include one or more of the following features. The tab may be one of a pair of opposed tabs formed along a wall of the socket, each tab of the pair carrying a respective cleat on an inner surface thereof. The tab may be integrally formed along a wall of the socket. The valve cap tool may further include a spring clip disposed within the socket, wherein the tab is a clip tab of the spring clip, and wherein the cleat is a clip cleat carried by the clip tab, and wherein the socket includes a retention aperture configured to receive and secure the spring clip. The valve cap tool may further include a deflator nub projecting from an exterior surface of the tool body adjacent the socket, the deflator nub configured to depress a valve core of a tire valve. The valve cap tool may further include a grip section at an end of the tool body opposite the socket. The socket may have a polygonal interior cross-section configured to transmit rotational torque to the valve cap. The valve cap tool may further include a bore extending through the tool body and communicating with the socket, and a cap ejector slidably disposed within the bore, the cap ejector movable to dislodge the valve cap from the socket. The valve cap tool may further include an ejector retention rod extending through the tool body and through a slot in the cap ejector to retain the cap ejector within the tool body while permitting axial movement of the cap ejector. The valve cap tool may further include a second socket defined at an end of the tool body opposite the socket, the second socket configured to receive a second valve cap therein. The valve cap tool may further include a third socket and a fourth socket to provide four sockets arranged in a cruciform configuration. The valve cap tool may further include a hex shank at an end of the tool body opposite the socket, the hex shank configured for engagement by a powered driver. The valve cap tool may further include a shank groove formed circumferentially about the hex shank to receive a quick-change retaining mechanism. The valve cap tool may further include a pressure gauge coupled to the tool body, the pressure gauge including a gauge fitting configured to engage a tire valve stem. The valve cap tool may further include a flashlight body coupled to the tool body and a light source disposed on the flashlight body.

According to another aspect of the present disclosure, a valve cap tool system is provided. The valve cap tool system includes a tool body having a socket at one end thereof, the socket including a deflectable tab carrying a cleat on an inner surface of the tab. The valve cap tool system further includes a valve cap having a cap body with a circumferential groove formed on an exterior surface of the cap body, the circumferential groove configured to be engaged by the cleat when the valve cap is received within the socket to retain the valve cap within the socket.

According to other aspects of the present disclosure, the valve cap tool system may include one or more of the following features. The valve cap may further include a domed end closing one axial end of the cap body, and internal threads formed on an inner surface of the cap body at an end opposite the domed end, the internal threads configured to engage external threads of a tire valve stem. The cleat may be configured to deflect outwardly upon insertion of the valve cap into the socket and to snap inwardly into the circumferential groove to retain the valve cap. The valve cap tool system may further include a deflator nub projecting from an exterior surface of the tool body adjacent the socket, the deflator nub configured to depress a valve core of a tire valve. The socket may have a polygonal interior cross-section and the cap body may have a corresponding polygonal exterior cross-section to provide rotational engagement therebetween. The valve cap may further include a cap LED disposed within the cap body and a battery disposed within the cap body to power the cap LED, wherein the cap LED is configured to illuminate through the domed end when activated by a wireless signal.

According to another aspect of the present disclosure, a valve cap tool system is provided. The valve cap tool system includes a tool body having a socket at one end thereof, the socket including a deflectable tab carrying a cleat on an inner surface of the tab. The valve cap tool system further includes a keyring attachment device having an attachment body with a circumferential groove formed on an exterior surface of the attachment body, the circumferential groove configured to be engaged by the cleat when the keyring attachment device is received within the socket to retain the keyring attachment device within the socket. The keyring attachment device further includes a protrusion extending from the attachment body and a through hole formed in the protrusion configured to receive a keyring.

According to another aspect of the present disclosure, a method of removing a valve cap from a tire valve stem is provided. The method includes positioning a socket of a valve cap tool over a valve cap threaded onto a tire valve stem, the socket including a deflectable tab carrying a cleat. The method further includes inserting the valve cap into the socket such that the cleat engages a circumferential groove on an exterior surface of the valve cap to retain the valve cap within the socket. The method further includes rotating the valve cap tool to unthread the valve cap from the tire valve stem while the valve cap is retained within the socket.

According to other aspects of the present disclosure, the method may include one or more of the following features. The method may further include depressing a valve core of the tire valve stem with a deflator nub projecting from an exterior surface of the valve cap tool to release air from a tire. The method may further include positioning the socket over the tire valve stem with the valve cap retained therein, and rotating the valve cap tool in an opposite direction to thread the valve cap onto the tire valve stem. The method may further include, prior to positioning the socket over the valve cap, detaching the valve cap tool from a keyring attachment device retained within the socket by withdrawing the valve cap tool such that the cleat disengages from a circumferential groove on the keyring attachment device, and after rotating the valve cap tool to unthread the valve cap from the tire valve stem, performing tire maintenance and threading the valve cap back onto the tire valve stem, and reinserting the keyring attachment device into the socket such that the cleat engages the circumferential groove on the keyring attachment device to retain the keyring attachment device within the socket.

For a more complete understanding, reference is made to the following detailed description and accompanying drawings. In the drawings, like reference characters refer to like parts throughout the views in which:

### BRIEF DESCRIPTION OF THE DRAWINGS

FIG. 1 illustrates an isometric view of a cap removal tool, in accordance with an embodiment of the disclosure;

FIG. 2 illustrates an enlarged orthogonal view of a head end of the cap removal tool of FIG. 1, in accordance with an embodiment of the disclosure;

FIG. 3 illustrates a longitudinal cross-sectional view of the head end of the cap removal tool of FIG. 1, in accordance with an embodiment of the disclosure;

FIG. 4 illustrates a perspective view of a valve cap, in accordance with an embodiment of the disclosure;

FIG. 5 illustrates a perspective view of the valve cap of FIG. 4 showing an open end, in accordance with an embodiment of the disclosure;

FIG. 6 illustrates a side orthogonal view of the valve cap of FIG. 4, in accordance with an embodiment of the disclosure;

FIG. 7 illustrates a perspective view of the head end of the cap removal tool with a valve cap retained therein, in accordance with an embodiment of the disclosure;

FIG. 8 illustrates a side orthogonal view of a double-ended tool, in accordance with an embodiment of the disclosure;

FIG. 9 illustrates a side view of a cap removal tool incorporating an integrated cap ejector, in accordance with an embodiment of the disclosure;

FIG. 10 illustrates an isometric view of a socket bit tool, in accordance with an embodiment of the disclosure;

FIG. 11 illustrates a perspective view of a pressure gauge tool, in accordance with an embodiment of the disclosure;

FIG. 12 illustrates an isometric view of a keychain tool, in accordance with an embodiment of the disclosure;

FIG. 13 illustrates an isometric view of a four-way tool, in accordance with an embodiment of the disclosure;

FIG. 14 illustrates a perspective view of a valve cap with an integrated light source, in accordance with an embodiment of the disclosure;

FIG. 15 illustrates a longitudinal cross-sectional view of a head end of a cap removal tool with a spring clip, in accordance with an embodiment of the disclosure;

FIG. 16 illustrates a perspective view of a keyring attachment device received within a socket of a cap removal tool, in accordance with an embodiment of the disclosure; and

FIG. 17 illustrates an exploded perspective view of the keyring attachment device of FIG. 16 and the cap removal tool configured to receive the keyring attachment device, in accordance with an embodiment of the disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to a valve cap tool and a valve cap tool system configured for engaging, retaining, and manipulating valve caps during removal from and replacement onto tire valve stems. The valve cap tool may be used in connection with pneumatic tires on automobiles, trucks, motorcycles, bicycles, recreational vehicles, trailers, and various types of farm, construction, and industrial equipment. The valve cap tool may facilitate tire pressure maintenance by providing a convenient means for handling valve caps without direct finger contact, thereby reducing the likelihood of dropping or misplacing valve caps during tire servicing operations.

In some cases, the valve cap tool may include a socket configured to receive and retain a valve cap therein. The socket may include a retention mechanism that engages a corresponding feature on the valve cap to secure the valve cap within the socket during removal and replacement operations. The valve cap tool may be configured to transmit rotational torque to the valve cap to thread and unthread the valve cap relative to a tire valve stem.

In some cases, the valve cap tool system may include a valve cap tool and a valve cap configured for cooperative engagement with the valve cap tool. The valve cap may include features that facilitate retention within the valve cap tool during handling operations.

The valve cap tool may be provided in various configurations to accommodate different use cases and user preferences. In some cases, the valve cap tool may include additional features such as a deflator nub for releasing air from a tire, a grip section for manual handling, or integration with other tire servicing components. The valve cap tool may be configured as a handheld device, a powered driver attachment, or a compact portable device suitable for carrying on a keychain or in a pocket.

Based upon the foregoing disclosure, it is seen that the present disclosure provides a valve cap tool and valve cap tool system that may reduce the likelihood of losing or misplacing valve caps during tire servicing operations. The valve cap tool may allow a user to remove and replace valve caps without direct finger contact with the valve cap, which may be beneficial when valve caps are soiled with road grime or brake dust, or when a user is wearing gloves. The valve cap tool may also provide a convenient means for retaining a valve cap during tire pressure measurement, thereby streamlining the tire servicing process.

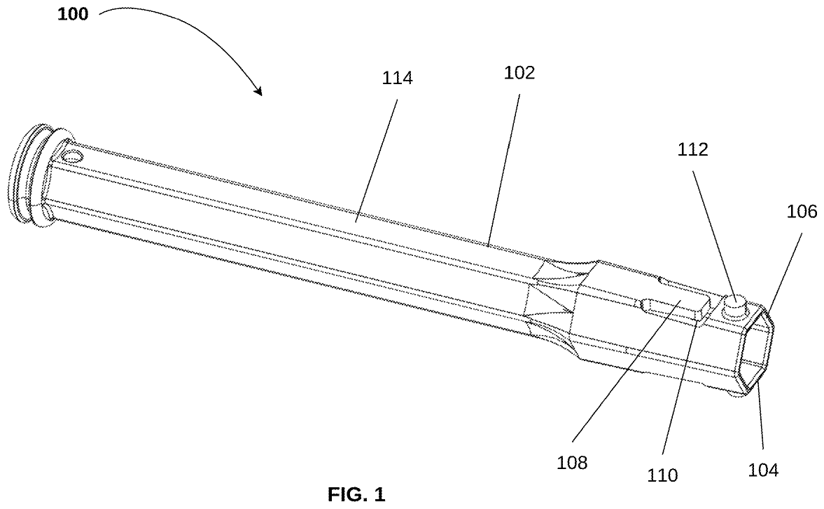

FIG. 1 illustrates an isometric view of a cap removal tool 100. The cap removal tool 100 includes a tool body 102 extending between a grip section 114 at one end and a socket 104 at an opposite end. The grip section 114 may have a generally cylindrical shaft profile suitable for manual gripping. The socket 104 is defined at one end of the tool body 102 and is configured to receive a valve cap therein. A socket opening 106 is located at a distal end face of the socket 104 to admit a valve cap into the socket 104.

A tab 108 is disposed within the socket 104. In the embodiment shown, the tab 108 is integrally formed along a wall of the socket 104. The tab 108 is deflectable and carries a cleat 110 on an inner surface thereof. The cleat 110 is configured to engage a circumferential groove on an exterior surface of a valve cap to retain the valve cap within the socket 104. In some cases, the tab 108 may be one of a pair of opposed tabs formed along a wall of the socket 104, with each tab of the pair carrying a respective cleat on an inner surface thereof. When a valve cap is inserted into the socket 104, the tab 108 may deflect outwardly to permit entry of the valve cap, and the cleat 110 may then snap inwardly into the circumferential groove on the valve cap to secure the valve cap within the socket 104.

A deflator nub 112 projects from an exterior surface of the tool body 102 adjacent the socket 104. The deflator nub 112 is configured to depress a valve core of a tire valve to release air from a tire. The deflator nub 112 may be positioned on a head portion of the tool body 102 near the socket opening 106 to provide convenient access to the valve core during tire servicing operations.

The socket 104 may be defined within an enlarged head portion of the tool body 102 having a polygonal exterior. The polygonal configuration of the socket 104 may facilitate transmission of rotational torque to a valve cap received therein, allowing a user to thread and unthread the valve cap relative to a tire valve stem by rotating the cap removal tool 100.

Based upon the foregoing disclosure, it is seen that the present disclosure provides a cap removal tool 100 that may allow a user to engage, retain, and manipulate a valve cap during removal from and replacement onto a tire valve stem. The deflectable tab 108 disposed within the socket 104 with cleat 110 may provide a retention mechanism that secures the valve cap within the socket 104, reducing the likelihood of dropping or misplacing the valve cap during tire servicing. The grip section 114 may provide a comfortable gripping surface for manual operation, and the deflator nub 112 may allow a user to release air from a tire without requiring a separate tool.

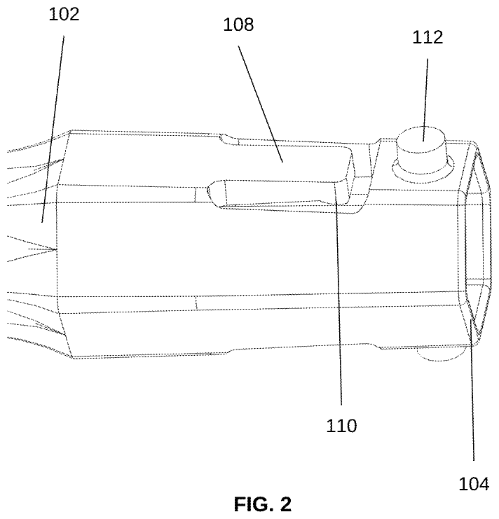

FIG. 2 illustrates an enlarged orthogonal view of a head end of the cap removal tool 100. The tool body 102 transitions from a fluted rear portion into a head portion that defines the socket 104. The tab 108 is formed along a wall of the socket 104 and is deflectable outwardly upon insertion of a valve cap. The cleat 110 is provided on an inner surface of the tab 108 and is positioned to seat into a circumferential groove of a valve cap to retain the valve cap within the socket 104. The deflator nub 112 projects from an exterior surface of the head portion adjacent the socket 104 and is configured to depress a valve core for releasing air from a tire.

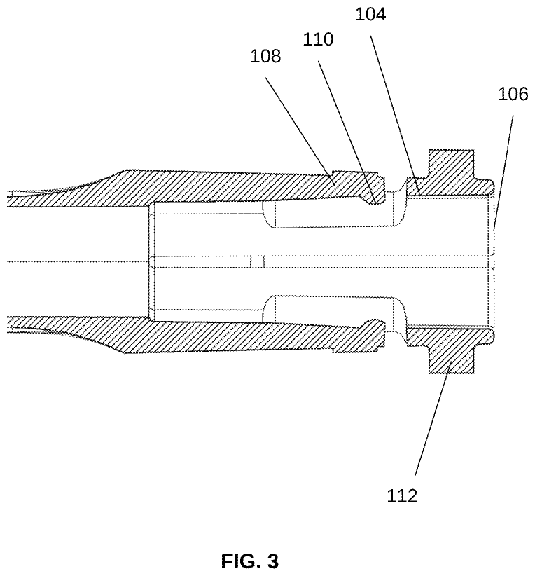

FIG. 3 illustrates a longitudinal cross-sectional view of the head end of the cap removal tool 100. The cross-sectional view reveals an internal configuration of the socket 104. The socket 104 is defined within the head portion of the tool body 102 and includes an interior cavity sized to receive a valve cap. The socket opening 106 is located at a distal end face of the socket 104 and provides an entry point through which a valve cap is inserted. The tab 108 is formed along a wall of the socket 104 and is shown in cross-section, illustrating a position of the tab 108 relative to the socket interior. The cleat 110 is disposed on an inner surface of the tab 108. The deflator nub 112 projects from an exterior surface of the head portion adjacent the socket opening 106. The longitudinal section reveals a spatial relationship between the socket interior and the deflectable tab 108 with the cleat 110, illustrating a retention mechanism that secures a valve cap within the socket 104 during removal from and replacement onto a tire valve stem.

In some cases, the tab 108 may be configured with three tabs spaced at 120-degree intervals around a circumference of the socket 104 to provide more uniform retention force distribution. In some cases, the tab 108 may be configured with four tabs spaced at 90-degree intervals around the circumference of the socket 104 for enhanced grip stability.

The cleat 110 may have various profile configurations on the inner surface of the tab 108. In some cases, the cleat 110 may have a rounded bead shape profile. In some cases, the cleat 110 may have a sharp ridge profile. In some cases, the cleat 110 may have a ramped profile that facilitates easier insertion of a valve cap while maintaining secure retention within the socket 104. The cleat 110 may be positioned at varying heights along a length of the tab 108 to accommodate valve caps with circumferential grooves at different positions.

As described above, the socket 104 may have a polygonal interior cross-section configured to transmit rotational torque to a valve cap received therein. The polygonal interior cross-section of the socket 104 engages a corresponding polygonal exterior surface of a valve cap to provide rotational engagement therebetween, allowing a user to thread and unthread the valve cap relative to a tire valve stem by rotating the cap removal tool 100.

The deflator nub 112 may be configured with various tip geometries. In some cases, the deflator nub 112 may be configured with a pointed conical tip for precise valve core depression. In some cases, the deflator nub 112 may be configured with a flat cylindrical tip for broader contact with a valve core. In some cases, the deflator nub 112 may be configured with a chisel-shaped tip. The deflator nub 112 may be positioned at different axial locations along the tool body 102 to accommodate user preference. In some cases, the deflator nub 112 may be retractable so that the deflator nub 112 can be extended when air release is desired and retracted when not in use to prevent accidental valve depression.

Based upon the foregoing disclosure, it is seen that the present disclosure provides a socket 104 and retention mechanism that may securely retain a valve cap during tire servicing operations. The deflectable tab 108 with cleat 110 may engage a circumferential groove on a valve cap to prevent the valve cap from being dropped or misplaced. The polygonal interior cross-section of the socket 104 may facilitate transmission of rotational torque to thread and unthread a valve cap relative to a tire valve stem. The deflator nub 112 may provide convenient access to release air from a tire without requiring a separate tool.

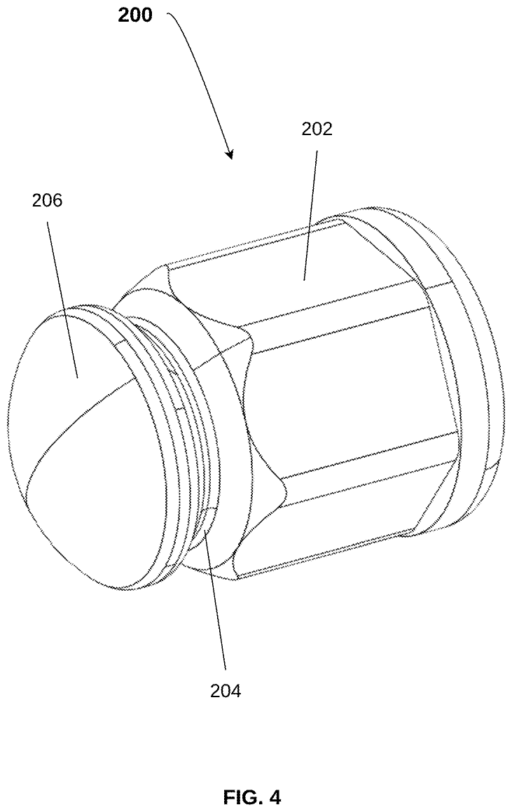

FIG. 4 illustrates a perspective view of a valve cap 200. The valve cap 200 includes a cap body 202 having a generally cylindrical configuration. A circumferential groove 204 is formed on an exterior surface of the cap body 202. A domed end 206 closes one axial end of the cap body 202. The domed end 206 provides a smooth curved surface that facilitates insertion of the valve cap 200 into the socket 104 of the cap removal tool 100. The circumferential groove 204 is positioned on the exterior surface of the cap body 202 between the domed end 206 and an opposite open end of the valve cap 200.

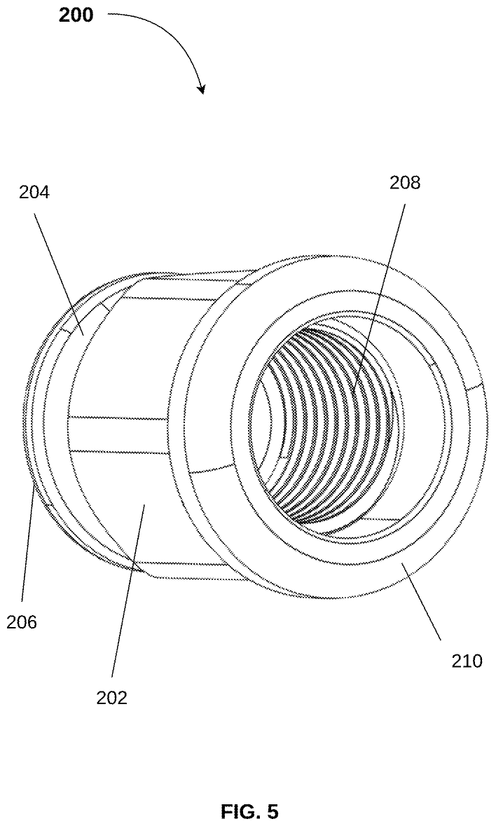

FIG. 5 illustrates a perspective view of the valve cap 200 oriented to show the open end. A threaded end 210 of the cap body 202 defines the open end of the valve cap 200. Internal threads 208 are formed on an inner surface of the cap body 202 at the threaded end 210. The internal threads 208 are configured to engage external threads of a tire valve stem. The circumferential groove 204 is positioned on the exterior surface of the cap body 202 between the threaded end 210 and the domed end 206.

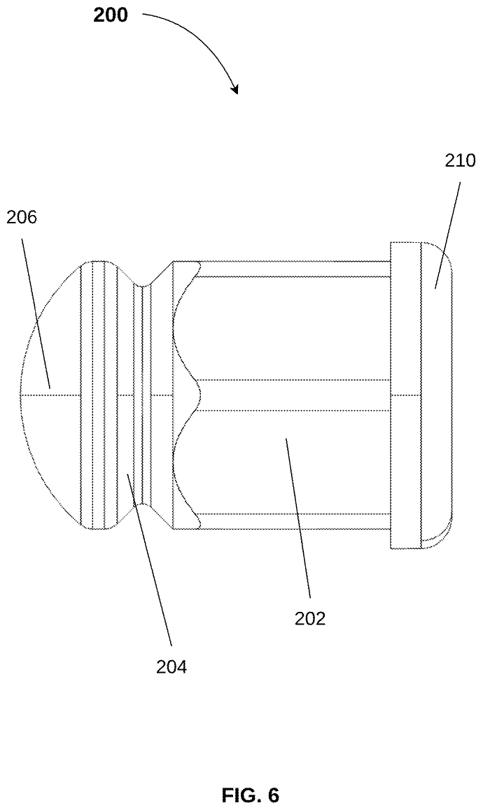

FIG. 6 illustrates a side orthogonal view of the valve cap 200. The cap body 202 extends axially between the domed end 206 and the threaded end 210. The circumferential groove 204 is configured to be engaged by the cleat 110 when the valve cap 200 is received within the socket 104 to retain the valve cap 200 within the socket 104. As described above, the socket 104 includes a deflectable tab 108 carrying the cleat 110 on an inner surface of the tab 108. When the valve cap 200 is inserted into the socket 104, the cleat 110 seats into the circumferential groove 204 to secure the valve cap 200 within the socket 104.

The circumferential groove 204 may be configured with various cross-sectional profiles. In some cases, the circumferential groove 204 may be configured with a V-shaped cross-sectional profile to provide a self-centering action when the cleat 110 engages the circumferential groove 204. In some cases, the circumferential groove 204 may be configured with a square cross-sectional profile to maximize the contact surface area between the cleat 110 and groove walls. In some cases, the circumferential groove 204 may be configured with a dovetail-shaped profile with an undercut to increase retention force. In some cases, the circumferential groove 204 may be configured as a series of discrete notches or recesses rather than a continuous circumferential channel to provide rotational indexing between the valve cap 200 and the cap removal tool 100.

As described above, the socket 104 may have a polygonal interior cross-section and the cap body 202 may have a corresponding polygonal exterior cross-section to provide rotational engagement therebetween. In some cases, the socket 104 interior and the cap body 202 exterior may be configured with matching triangular cross-sectional shapes to provide three-point engagement with 120-degree rotational symmetry. In some cases, the socket 104 interior and the cap body 202 exterior may be configured with matching square cross-sectional shapes to provide four-point engagement. In some cases, the socket 104 interior and the cap body 202 exterior may be configured with matching pentagonal, hexagonal, heptagonal, or octagonal cross-sectional shapes to provide progressively finer rotational indexing. The corners of the polygonal shapes of the socket 104 and the cap body 202 may be radiused to facilitate easier insertion while maintaining positive rotational engagement.

In some cases, the outer surface of the cap body 202 may be symmetrically shaped with three or more flat sides for engagement with the cap removal tool 100. In some cases, the outer surface of the cap body 202 may have a circular or cylindrical shape with fluted longitudinal ridges.

The domed end 206 may be configured with various shapes. While the closed end of the valve cap 200 is shown and described as a domed surface, the closed end may also take other forms. In some cases, the domed end 206 may be configured with a conical dome shape to facilitate easier socket engagement. In some cases, the domed end 206 may be configured with a stepped dome having multiple tiers for visual differentiation of caps intended for different tire types. In some cases, the domed end 206 may incorporate a central dimple or recess to assist in centering the socket 104 during engagement. In some cases, the domed end 206 may be configured as a flat top instead of a hemispherical dome. In some cases, the closed end may be configured as a squared off blunt tip or any other suitable shape. In some cases, the domed end 206 may include a recessed or extended screwdriver bit design such as slotted, philips, square, torx, hex, or spider shape.

Based upon the foregoing disclosure, it is seen that the present disclosure provides a valve cap 200 configured for cooperative engagement with the cap removal tool 100. The circumferential groove 204 on the exterior surface of the cap body 202 may engage the cleat 110 carried by the deflectable tab 108 within the socket 104 to retain the valve cap 200 during removal from and replacement onto a tire valve stem. The internal threads 208 at the threaded end 210 may engage external threads of a tire valve stem to secure the valve cap 200 to the tire valve stem. The domed end 206 may facilitate insertion of the valve cap 200 into the socket 104. The polygonal exterior cross-section of the cap body 202 may provide rotational engagement with the polygonal interior cross-section of the socket 104 to transmit rotational torque during threading and unthreading operations.

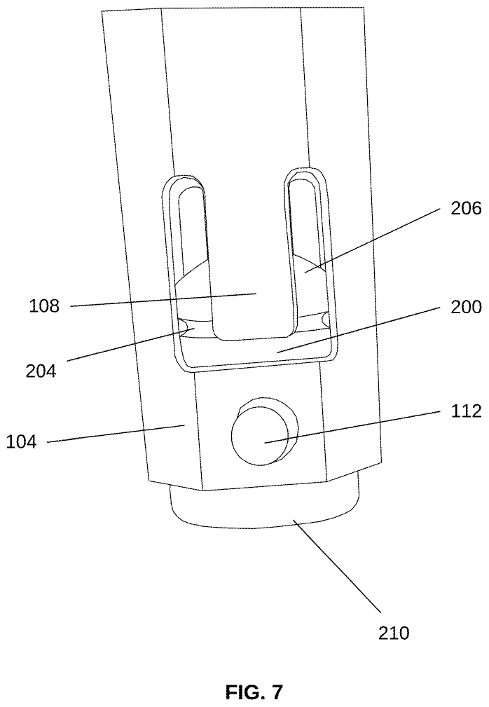

FIG. 7 illustrates a perspective view of a head end of the cap removal tool 100 with the valve cap 200 retained within the socket 104. The tool body 102 transitions into a head portion defining the socket 104, with the tab 108 formed along a wall of the socket 104 and the deflator nub 112 projecting from an exterior surface of the head portion adjacent the socket 104. The deflator nub 112 is configured to depress a valve core of a tire valve to release air from a tire.

The valve cap 200 is shown seated within the socket 104 with the circumferential groove 204 of the valve cap 200 aligned with the cleat 110 carried by the tab 108. The domed end 206 of the valve cap 200 faces the socket opening 106, and the threaded end 210 of the valve cap 200 projects axially within the socket 104 opposite the domed end 206.

The cleat 110 is configured to deflect outwardly upon insertion of the valve cap 200 into the socket 104 and to snap inwardly into the circumferential groove 204 to retain the valve cap 200. When the valve cap 200 is inserted into the socket 104, the domed end 206 contacts the cleat 110 and causes the tab 108 to deflect outwardly as the cap body 202 passes the cleat 110. Once the circumferential groove 204 reaches the position of the cleat 110, the tab 108 returns inwardly and the cleat 110 seats into the circumferential groove 204. The engagement between the cleat 110 and the circumferential groove 204 retains the valve cap 200 within the socket 104 during removal from and replacement onto a tire valve stem.

The alignment between the circumferential groove 204 and the cleat 110 may provide a snap-fit retention that resists inadvertent dislodgement of the valve cap 200 from the socket 104. In some cases, the depth of the circumferential groove 204 and the projection of the cleat 110 may be configured to provide a retention force that secures the valve cap 200 within the socket 104 while permitting intentional removal of the valve cap 200 when desired.

Based upon the foregoing disclosure, it is seen that the present disclosure provides a valve cap tool system in which the valve cap 200 may be retained within the socket 104 through engagement between the cleat 110 and the circumferential groove 204. The deflectable tab 108 carrying the cleat 110 may permit insertion of the valve cap 200 into the socket 104 and may provide a snap-fit retention that secures the valve cap 200 during tire servicing operations. The deflator nub 112 projecting from the exterior surface of the tool body 102 adjacent the socket 104 may allow a user to release air from a tire without requiring a separate tool.

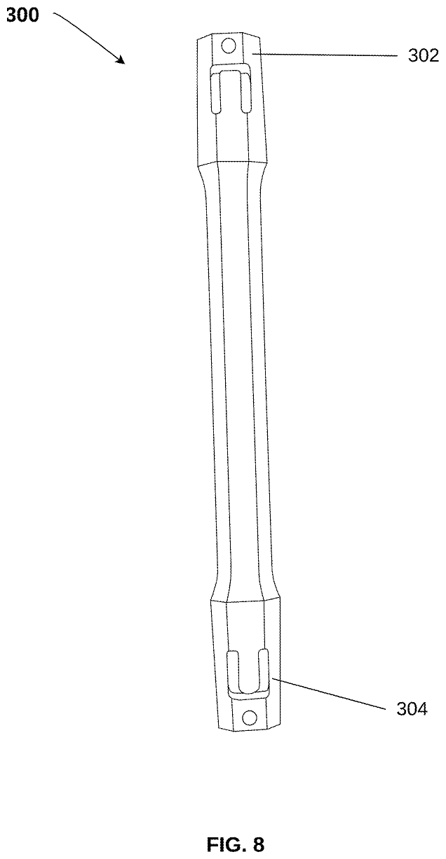

FIG. 8 illustrates a side orthogonal view of a double-ended tool 300. The double-ended tool 300 has an elongated body that tapers through a narrowed central region and widens toward each axial end. A first socket 302 is formed at one end of the double-ended tool 300 and a second socket 304 is formed at an opposite end of the double-ended tool 300. The second socket 304 is configured to receive a second valve cap therein.

Each of the first socket 302 and the second socket 304 includes a pair of opposed slotted tabs that define deflectable retention features for engaging a corresponding valve cap. The opposed slotted tabs of the first socket 302 and the second socket 304 may each carry a cleat on an inner surface thereof, with the cleat configured to engage a circumferential groove on an exterior surface of a valve cap to retain the valve cap within the respective socket. When a valve cap is inserted into the first socket 302 or the second socket 304, the opposed slotted tabs may deflect outwardly to permit entry of the valve cap, and the cleats may then snap inwardly into the circumferential groove on the valve cap to secure the valve cap within the socket.

The double-ended configuration of the double-ended tool 300 enables a user to retain a valve cap at each end simultaneously. In some cases, a user may retain a first valve cap within the first socket 302 and a second valve cap within the second socket 304 during tire servicing operations involving multiple tires. In some cases, the first socket 302 and the second socket 304 may be configured with different interior dimensions to accommodate valve caps of different sizes.

In some cases, the narrowed central region of the double-ended tool 300 may provide a grip surface for manual handling. In some cases, the double-ended tool 300 may include a deflator nub projecting from an exterior surface adjacent the first socket 302 or the second socket 304 to depress a valve core for releasing air from a tire.

Based upon the foregoing disclosure, it is seen that the present disclosure provides a double-ended tool 300 that may allow a user to engage, retain, and manipulate valve caps at both ends of the tool simultaneously. The first socket 302 and the second socket 304 with opposed slotted tabs may provide retention mechanisms that secure valve caps within the respective sockets, reducing the likelihood of dropping or misplacing valve caps during tire servicing operations involving multiple tires. The double-ended configuration may allow a user to service multiple tires in sequence without setting aside a removed valve cap.

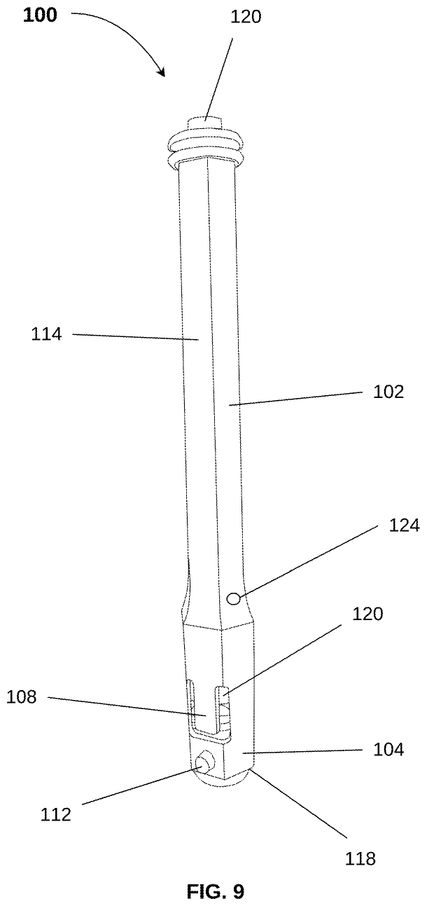

FIG. 9 illustrates a side view of the cap removal tool 100 incorporating an integrated cap ejector 120. The cap removal tool 100 includes the tool body 102 extending from the grip section 114 at one end to the socket 104 at an opposite end. As described above, the socket 104 includes the tab 108 formed along a wall of the socket 104 and the deflator nub 112 projecting from an exterior surface of the tool body 102 adjacent the socket 104.

A bore 118 extends through the tool body 102 and communicates with the socket 104. The bore 118 provides a passage through which a cap ejector 120 may travel to contact a valve cap retained within the socket 104. The cap ejector 120 is slidably disposed within the bore 118 and is movable to dislodge a valve cap from the socket 104. The cap ejector 120 projects from an upper end of the tool body 102 at the grip section 114, and an opposed end of the cap ejector 120 is positioned at the socket end where the cap ejector 120 is movable through the bore 118 to contact and dislodge a retained valve cap from the socket 104.

An ejector retention rod 124 extends through the tool body 102 and through a slot in the cap ejector 120 to retain the cap ejector 120 within the tool body 102 while permitting axial movement of the cap ejector 120. The ejector retention rod 124 is secured to walls of the tool body 102 and extends across a diameter of the bore 118. The slot in the cap ejector 120 permits a degree of axial movement of the cap ejector 120 within the bore 118, but the ejector retention rod 124 prevents the cap ejector 120 from sliding out of the tool body 102.

In some cases, the cap ejector 120 may be spring-loaded to automatically eject a valve cap when a button is pressed. A spring-loaded configuration may provide one-handed operation, allowing a user to eject a retained valve cap without repositioning the hand on the tool body 102.

In some cases, the cap ejector 120 may be threaded so that the cap ejector 120 advances when the cap removal tool 100 is rotated in a specific direction. A threaded configuration may provide controlled ejection of a valve cap from the socket 104.

In some cases, the cap ejector 120 may be lever-actuated with a lever positioned on the tool body 102. A lever-actuated configuration may allow ejection of a valve cap without repositioning the hand on the tool body 102.

In some cases, the cap ejector 120 may incorporate a detent or friction mechanism to hold the cap ejector 120 in a retracted position during normal use. A detent or friction mechanism may prevent inadvertent advancement of the cap ejector 120 during tire servicing operations.

Based upon the foregoing disclosure, it is seen that the present disclosure provides a cap removal tool 100 with an integrated cap ejector 120 that may allow a user to dislodge a retained valve cap from the socket 104 without direct finger contact with the valve cap. The bore 118 extending through the tool body 102 and communicating with the socket 104 may provide a passage for the cap ejector 120 to travel and contact a retained valve cap. The ejector retention rod 124 extending through the tool body 102 and through a slot in the cap ejector 120 may retain the cap ejector 120 within the tool body 102 while permitting axial movement of the cap ejector 120 to dislodge a valve cap from the socket 104.

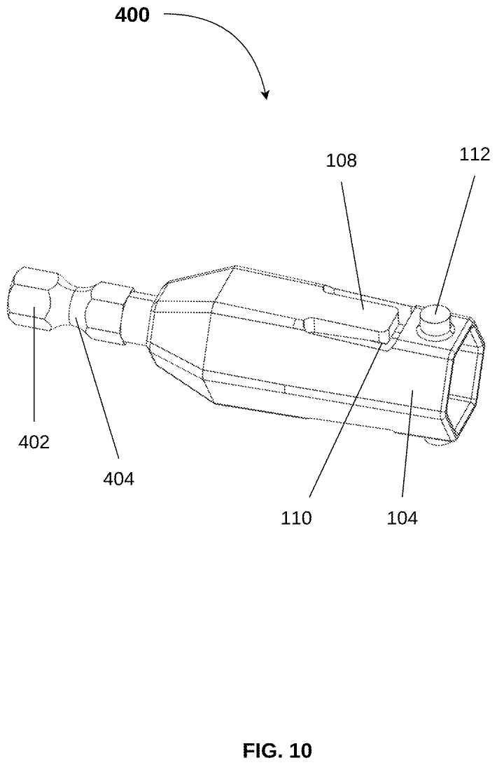

FIG. 10 illustrates an isometric view of a socket bit tool 400. The socket bit tool 400 includes a hex shank 402 at one end and a socket 104 at an opposite end. The hex shank 402 is configured for engagement by a powered driver such as a cordless drill, cordless or electric screwdriver, impact driver, or other rotary tool. The socket 104 is configured to receive a valve cap therein and includes a tab 108 formed along a wall of the socket 104 carrying a cleat 110 on an inner surface thereof. As described above, the cleat 110 is configured to engage a circumferential groove on an exterior surface of a valve cap to retain the valve cap within the socket 104. A deflator nub 112 projects from an exterior surface of the socket bit tool 400 adjacent the socket 104 and is configured to depress a valve core of a tire valve to release air from a tire.

A shank groove 404 is formed circumferentially about the hex shank 402. The shank groove 404 is configured to receive a quick-change retaining mechanism of a powered driver. The shank groove 404 may engage a spring-loaded ball detent or similar retention feature within a quick-change chuck to secure the socket bit tool 400 within the powered driver while permitting tool-free removal when desired.

The socket bit tool 400 may incorporate a quick-release mechanism that allows tool-free attachment and removal from a drill chuck. In some cases, the quick-release mechanism may include the shank groove 404 cooperating with a spring-loaded collar on the drill chuck to provide secure attachment while permitting rapid tool changes.

In some cases, the hex shank 402 may be magnetic to provide secure attachment while allowing easy removal from a drill chuck. A magnetic hex shank 402 may maintain engagement with a magnetic bit holder during powered operation and may facilitate alignment when inserting the socket bit tool 400 into a drill chuck.

In some cases, the hex shank 402 may be configured with different shank lengths to accommodate various drill chuck depths and to provide different reach distances. A longer hex shank 402 may provide increased reach for accessing valve stems in recessed wheel wells or behind hubcaps. A shorter hex shank 402 may provide a more compact configuration for general use.

In some cases, the socket bit tool 400 may include a universal adapter that accepts multiple socket sizes to allow the same tool to work with different cap configurations. A universal adapter may include interchangeable socket inserts that snap into a common socket housing, allowing a user to select a socket size appropriate for a particular valve cap.

In some cases, the hex shank 402 may be configured with a round shank profile instead of a hexagonal profile for use with three-jaw drill chucks. In some cases, the hex shank 402 may be configured with a square drive profile for use with socket wrenches or ratchet handles. In some cases, the hex shank 402 may be configured with a splined profile for use with specialized power tools.

The socket bit tool 400 enables powered removal and replacement of valve caps using a rotary driver. When the socket bit tool 400 is inserted into a powered driver and the socket 104 is positioned over a valve cap threaded onto a tire valve stem, actuation of the powered driver rotates the socket bit tool 400 to unthread the valve cap from the tire valve stem. The tab 108 with cleat 110 retains the valve cap within the socket 104 during and after the unthreading operation. To replace the valve cap, the socket 104 with the retained valve cap is positioned over the tire valve stem and the powered driver is actuated in an opposite rotational direction to thread the valve cap onto the tire valve stem.

Based upon the foregoing disclosure, it is seen that the present disclosure provides a socket bit tool 400 that may allow powered removal and replacement of valve caps using a rotary driver. The hex shank 402 configured for engagement by a powered driver may enable rapid tire servicing operations, and the shank groove 404 formed circumferentially about the hex shank 402 may receive a quick-change retaining mechanism for tool-free attachment and removal. The socket 104 with deflectable tab 108 and cleat 110 may retain a valve cap during powered operation, and the deflator nub 112 may allow a user to release air from a tire without requiring a separate tool.

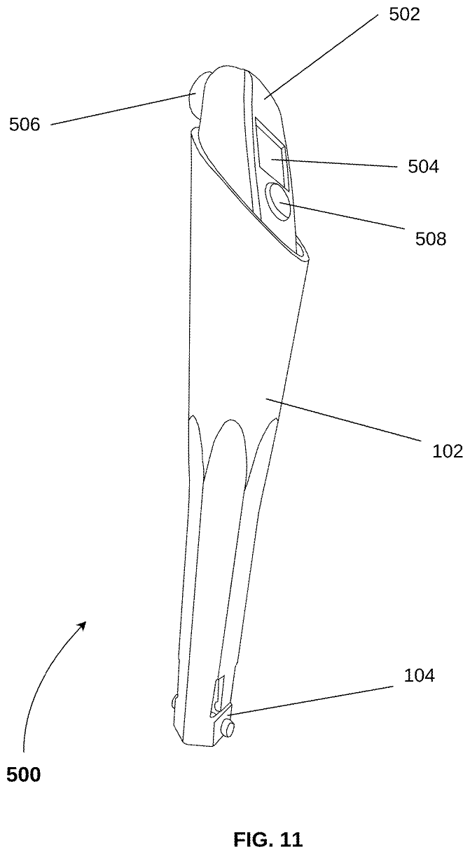

FIG. 11 illustrates a perspective view of a pressure gauge tool 500. The pressure gauge tool 500 includes a pressure gauge body 502 at one end and a tool body 102 extending therefrom to a socket 104 at an opposite end. The pressure gauge tool 500 integrates valve cap removal and retention functionality with tire pressure measurement in a single handheld device.

The pressure gauge body 502 houses pressure measurement components. A gauge display 504 is disposed on an exterior face of the pressure gauge body 502 to present pressure readings to a user. A gauge button 508 is positioned on the pressure gauge body 502 to control operation of the pressure gauge tool 500. A gauge fitting 506 projects from the pressure gauge body 502 and is configured to engage a tire valve stem to communicate tire pressure to the pressure gauge tool 500. The pressure gauge is coupled to the tool body 102, and the gauge fitting 506 is configured to engage a tire valve stem for pressure measurement.

The socket 104 at the opposite end of the tool body 102 is configured to receive and retain a valve cap. As described above, the socket 104 may include a deflectable tab carrying a cleat on an inner surface thereof, with the cleat configured to engage a circumferential groove on an exterior surface of a valve cap to retain the valve cap within the socket 104.

In some cases, the pressure gauge body 502 may be positioned coaxially with a tool axis, with the gauge display 504 oriented perpendicular to a length of the tool body 102 to allow reading while the pressure gauge tool 500 is engaged with a tire valve. In some cases, the pressure gauge body 502 may have a flexible gooseneck connection to allow the gauge display 504 to be positioned for a desired viewing angle.

In some cases, the pressure gauge tool 500 may incorporate a maximum pressure indicator needle that remains at a highest measured pressure until manually reset. In some cases, the gauge button 508 may be configured to select pressure units including PSI, kPa, and bar to accommodate international users.

In some cases, the gauge display 504 may include a backlit screen for low-light visibility. In some cases, the gauge display 504 may incorporate color-coded indicators that change from red to yellow to green based on whether a measured pressure is below, at, or above a user-programmable target pressure.

In some cases, the pressure gauge tool 500 may include an audible alert that sounds when a target pressure is reached to assist during inflation. In some cases, the pressure gauge tool 500 may include memory storage for multiple target pressures corresponding to different vehicles or tire positions.

In some cases, the pressure gauge tool 500 may incorporate a digital temperature sensor to display tire temperature alongside pressure. In some cases, the pressure gauge tool 500 may incorporate temperature compensation circuitry to automatically adjust pressure readings to a standard reference temperature.

In some cases, the pressure gauge tool 500 may incorporate Bluetooth connectivity to allow pressure readings to be transmitted to a smartphone application for logging and analysis. In some cases, the pressure gauge tool 500 may incorporate NFC capability to allow the pressure gauge tool 500 to read tire information from NFC-enabled tire pressure monitoring sensors.

Based upon the foregoing disclosure, it is seen that the present disclosure provides a pressure gauge tool 500 that may integrate valve cap removal and retention functionality with tire pressure measurement in a single handheld device. The pressure gauge body 502 with gauge display 504 and gauge fitting 506 may allow a user to measure tire pressure, while the socket 104 at the opposite end of the tool body 102 may allow the user to remove and retain a valve cap during tire servicing. The gauge button 508 may provide user control over pressure unit selection and other gauge functions. The pressure gauge tool 500 may streamline tire servicing operations by combining multiple functions into a single tool, reducing the number of separate tools a user carries.

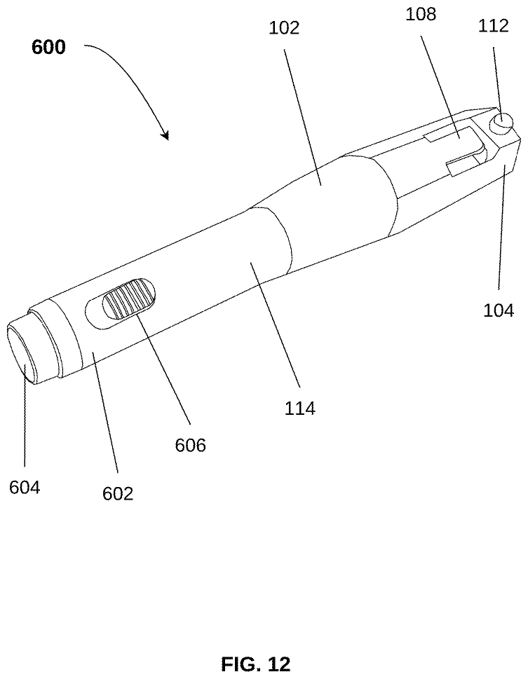

FIG. 12 illustrates an isometric view of a keychain tool 600. The keychain tool 600 includes a tool body 102 extending between a grip section 114 at one end and a socket 104 at an opposite end. The grip section 114 has a generally cylindrical profile suitable for manual gripping. The socket 104 is configured to receive and retain a valve cap and includes a tab 108 formed along a wall of the socket 104. As described above, the tab 108 carries a cleat on an inner surface thereof for engaging a circumferential groove on a received valve cap to retain the valve cap within the socket 104. A deflator nub 112 projects from an exterior surface of the tool body 102 adjacent the socket 104 and is configured to depress a valve core to release air from a tire.

The keychain tool 600 further includes a flashlight body 602 coupled to the tool body 102 at an end opposite the socket 104. The flashlight body 602 is coupled to the tool body 102 to provide integrated illumination functionality. A light source is disposed on the flashlight body 602. In some cases, the light source may be an LED 604 disposed on the flashlight body 602 to provide illumination during use in dark or low-light conditions. An on/off switch 606 is positioned on the flashlight body 602 to control activation of the LED 604.

The keychain tool 600 integrates valve cap removal and retention functionality with a built-in light source in a compact form factor suitable for attachment to a key ring. The compact configuration of the keychain tool 600 may allow a user to carry the keychain tool 600 on a key ring or in a pocket for convenient access during tire servicing operations.

In some cases, the LED 604 may be configured as multiple LEDs arranged in a ring around a socket opening of the socket 104 to illuminate a valve stem during cap removal and replacement. A ring arrangement of multiple LEDs may provide uniform illumination around the valve stem and valve cap during tire servicing operations in low-light conditions.

In some cases, the keychain tool 600 may incorporate a flexible light arm that can be positioned to direct light at a work area to accommodate various valve stem orientations. A flexible light arm may allow a user to adjust the direction of illumination based on the position and orientation of a tire valve stem.

In some cases, the LED 604 may incorporate different color options including white for general illumination and red for preserving night vision. White illumination may provide visibility for general tire servicing operations, while red illumination may preserve night vision adaptation when servicing tires in dark environments.

In some cases, the LED 604 may have an automatic light activation feature triggered by tool movement or orientation to conserve battery power. An automatic light activation feature may detect when the keychain tool 600 is picked up or oriented toward a work surface and may activate the LED 604 without requiring manual operation of the on/off switch 606. The automatic light activation feature may deactivate the LED 604 after a period of inactivity to conserve battery power.

In some cases, the on/off switch 606 may be configured as a push-button switch for momentary or latched activation. In some cases, the on/off switch 606 may be configured as a slide switch or rotary switch. In some cases, the on/off switch 606 may be configured as a twist-action switch integrated into the flashlight body 602.

In some cases, the LED 604 may be configured with multiple brightness levels selectable through the on/off switch 606. In some cases, the LED 604 may incorporate a strobe or flashing mode for emergency visibility.

Based upon the foregoing disclosure, it is seen that the present disclosure provides a keychain tool 600 that may integrate valve cap removal and retention functionality with a built-in light source in a compact form factor suitable for attachment to a key ring. The flashlight body 602 coupled to the tool body 102 and the LED 604 disposed on the flashlight body 602 may provide illumination during tire servicing operations in dark or low-light conditions. The on/off switch 606 may allow a user to control activation of the LED 604. The socket 104 with deflectable tab 108 may retain a valve cap during removal from and replacement onto a tire valve stem, and the deflator nub 112 may allow a user to release air from a tire without requiring a separate tool.

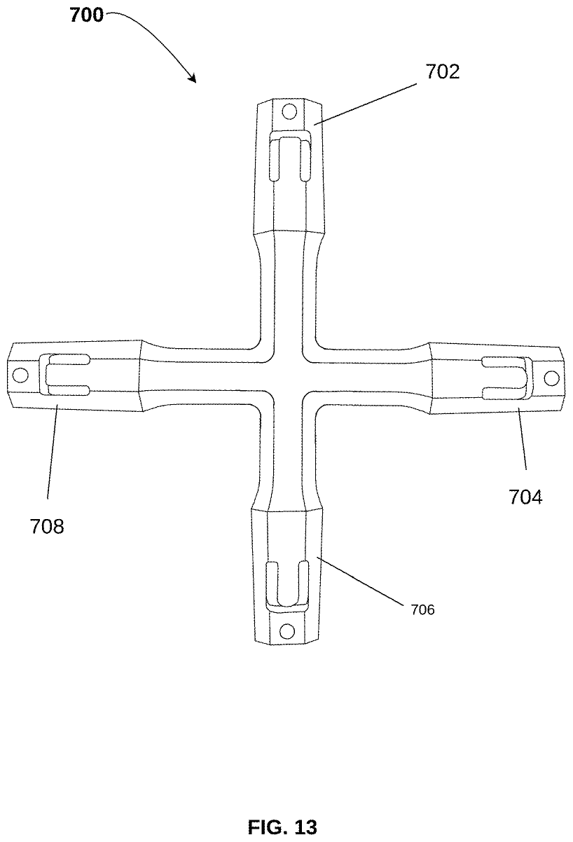

FIG. 13 illustrates an isometric view of a four-way tool 700. The four-way tool 700 has a cruciform configuration with four elongated arms extending outwardly from a central hub. A first socket 702 is formed at a distal end of one arm, a second socket 704 is formed at a distal end of an adjacent arm, a third socket 706 is formed at a distal end of another arm, and a fourth socket 708 is formed at a distal end of the remaining arm. Each of the first socket 702, second socket 704, third socket 706, and fourth socket 708 is configured to receive a valve cap therein. Each socket includes a tab formed along a wall of the socket, the tab being deflectable and carrying a cleat on an inner surface thereof configured to engage a circumferential groove on an exterior surface of a valve cap to retain the valve cap within the respective socket. The four arms of the four-way tool 700 are arranged at 90-degree intervals around the central hub, providing a balanced and symmetrical configuration.

Preferably, a deflator nub projects from an exterior surface of each arm adjacent each respective socket, the deflator nub configured to depress a valve core of a tire valve to release air from a tire. In some cases, only one of the four arms may include a deflator nub.

The four-way tool 700 enables a user to retain four valve caps simultaneously, one for each tire of a typical passenger vehicle. The four-way tool 700 accommodates users who prefer to remove all valve caps before adding air and then replace all caps after inflation is complete. A user may position each socket over a respective valve cap, insert the valve cap into the socket such that the cleat engages the circumferential groove on the valve cap, and rotate the four-way tool 700 to unthread the valve cap from the tire valve stem. The user may repeat this process for each of the four tires, retaining all four valve caps within the four-way tool 700 during tire servicing operations.

Based upon the foregoing disclosure, it is seen that the present disclosure provides a four-way tool 700 that may allow a user to engage, retain, and manipulate four valve caps simultaneously. The cruciform configuration with four sockets may facilitate tire servicing operations on vehicles with four tires by allowing a user to remove and retain all valve caps before adding air and then replace all caps after inflation is complete, reducing the likelihood of dropping or misplacing valve caps during tire servicing.

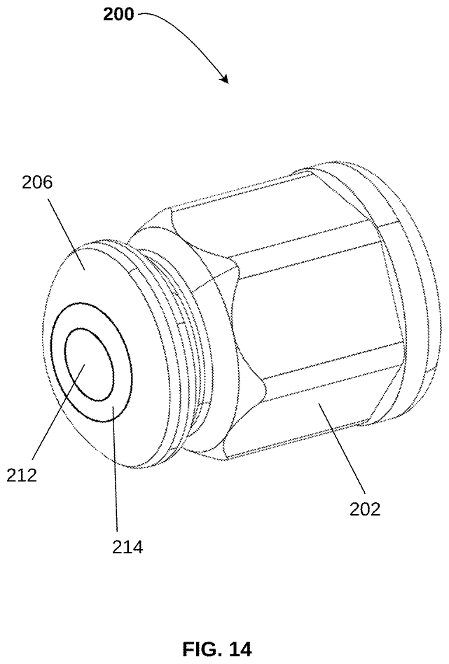

FIG. 14 illustrates a perspective view of a valve cap 200 configured with an integrated light source. The valve cap 200 includes a cap body 202 having a generally cylindrical configuration. A domed end 206 closes one axial end of the cap body 202. In this embodiment, the domed end 206 may be transparent or translucent to permit light to pass therethrough.

A cap LED 212 is disposed within the cap body 202 beneath the domed end 206. The cap LED 212 is configured to provide illumination that passes through the domed end 206 to make the valve cap 200 visible in dark or low-light conditions. A battery 214 is disposed within the cap body 202 to power the cap LED 212.

The cap LED 212 is illuminated when activated by a wireless signal sent by the tool, a smartphone, or other transmitting device. The wireless signal may be a Bluetooth signal, an RFID signal, an NFC signal, or any other suitable wireless communication protocol. In some cases, the wireless signal may be capable of operating at distances of 40 to 50 feet or more to accommodate use on larger vehicles such as semi trucks, where a user may wish to activate all valve caps simultaneously from a distance.

The cap LED 212 may be configured to automatically turn off after a short period of time to conserve battery life. The cap LED 212 may be provided in various colors for different purposes, such as visual differentiation between caps, indication of tire position, or aesthetic preference.

In some cases, the LED itself may be exposed at the closed end of the valve cap 200 in lieu of a separate domed cover. In such cases, the cap LED 212 may be positioned at the closed end of the cap body 202 without a transparent or translucent cover disposed over the cap LED 212.

The integration of the cap LED 212 and the battery 214 within the valve cap 200 allows a user, such as a semi truck driver walking along a vehicle at night, to activate a transmitting device and illuminate all valve caps simultaneously for easier identification in dark conditions.

Based upon the foregoing disclosure, it is seen that the present disclosure provides a valve cap 200 with an integrated light source that may assist users in locating valve caps in dark or low-light conditions. The cap LED 212 disposed within the cap body 202 and powered by the battery 214 may be activated by a wireless signal to illuminate through the domed end 206. The automatic turn-off feature may conserve battery life, and the various color options may provide visual differentiation between valve caps.

In some cases, a valve cap may be manufactured from phosphorescent or glow-in-the-dark material. If the LED-equipped valve cap is made of phosphorescent material, the cap may continue to glow for some time after the LED turns off. A non-LED valve cap made from phosphorescent material may glow after being briefly illuminated by a flashlight, streetlight, or other light source. The phosphorescent material may be of various colors for visual differentiation or aesthetic preference. The afterglow may persist for approximately 5 to 10 minutes after illumination. The phosphorescent material may be incorporated throughout the entire cap body or only in a portion such as the domed end.

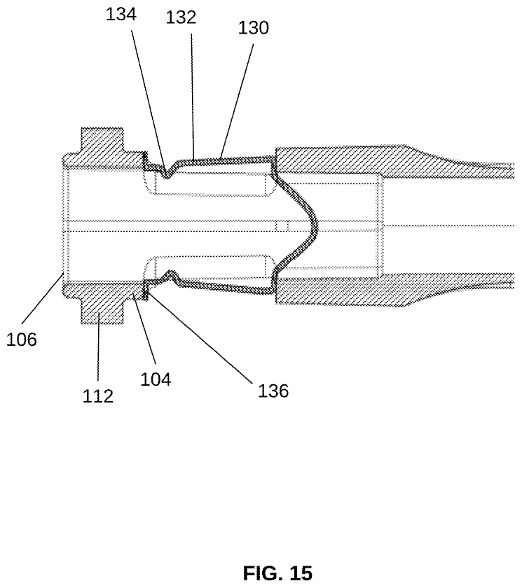

FIG. 15 illustrates a longitudinal cross-sectional view of a head end of a cap removal tool configured with a spring clip 130. The spring clip 130 is a separate component disposed within the socket 104 and provides an alternate retention mechanism in lieu of molded plastic tabs. The spring clip 130 may be more durable than molded plastic tabs, which may be brittle or prone to snapping over time. The spring clip 130 is a replaceable component that can be swapped out if worn.

The spring clip 130 includes a clip tab 132 that extends within the socket 104. The clip tab 132 is deflectable and carries a clip cleat 134 on an inner surface thereof. The clip cleat 134 is configured to engage a circumferential groove on an exterior surface of a valve cap to retain the valve cap within the socket 104. The clip tab 132 functions similarly to the tab 108 described above, but is part of the spring clip 130 rather than molded into the socket 104.

The socket 104 includes a retention aperture 136 formed in a wall of the socket 104. In this embodiment, the socket 104 has a modified construction wherein no molded tabs are provided. Instead, the retention aperture 136 is configured to receive and secure the spring clip 130. The spring clip 130 is inserted through the socket opening 106 and pushed inward until a portion of the spring clip 130 snaps into the retention aperture 136, securing the spring clip 130 in place within the socket 104.

The spring clip 130 is preferably formed of spring steel or similar resilient metal material having inherent springiness to permit deflection of the clip tab 132 during insertion and removal of a valve cap. In some cases, the spring clip 130 may be formed of other resilient materials such as phosphor bronze, beryllium copper, or a resilient polymer material.

Based upon the foregoing disclosure, it is seen that the present disclosure provides a spring clip 130 that may provide an alternate retention mechanism for securing a valve cap within the socket 104. The spring clip 130 with clip tab 132 and clip cleat 134 may offer increased durability compared to molded plastic tabs. The retention aperture 136 in the socket 104 may receive and secure the spring clip 130, and the spring clip 130 may be replaced if worn without requiring replacement of the entire tool.

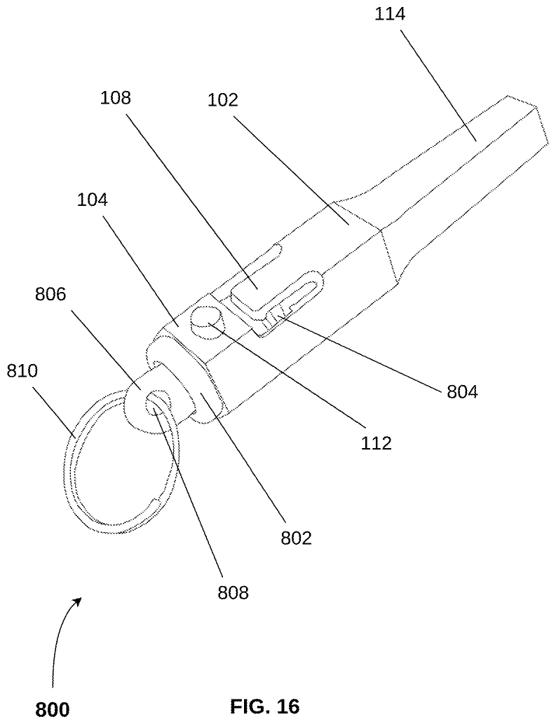

FIG. 16 illustrates a perspective view of a keyring attachment device 800 received within a socket 104 of a cap removal tool. The cap removal tool includes a tool body 102 extending between a grip section 114 at one end and the socket 104 at an opposite end. A tab 108 is disposed within the socket 104 and is deflectable to engage the keyring attachment device 800 received therein. A deflator nub 112 projects from an exterior surface of the tool body 102 adjacent the socket 104 and is configured to depress a valve core of a tire valve to release air from a tire.

The keyring attachment device 800 includes an attachment body 802 having an exterior shape configured for insertion into and retention within the socket 104. The attachment body 802 is shown seated within the socket 104, with the tab 108 engaging the attachment body 802 to retain the keyring attachment device 800 within the socket 104 in a manner similar to that used for retention of a valve cap. A domed end 804 is disposed at one axial end of the attachment body 802. A spade-like protrusion 806 extends from the attachment body 802 at an end opposite the domed end 804 and projects outwardly from the socket 104 when the keyring attachment device 800 is received therein. The spade-like protrusion 806 includes a through hole 808 formed therethrough, and a keyring 810 is received within the through hole 808 to permit attachment of the keyring attachment device 800 to a set of keys or other items carried by a user. The attachment body 802 is configured as a solid body without internal threads, distinguishing it from a threaded valve cap used for engaging tire valve stems.

The spade-like shape of the protrusion 806 is shown as one example embodiment. In some cases, the protrusion 806 may have other shapes, such as a generally cylindrical shaft with a through hole, a simple bracket or loop, or any other suitable shape having a through hole 808 configured to receive a keyring 810.

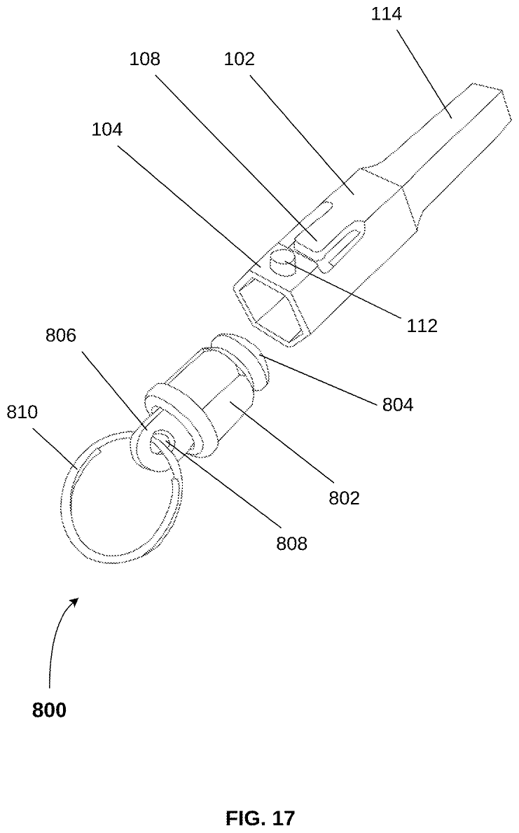

FIG. 17 illustrates an exploded perspective view of the keyring attachment device 800 and the cap removal tool configured to receive the keyring attachment device 800. The keyring attachment device 800 is shown axially aligned with and spaced apart from the socket 104 to illustrate the relationship between the keyring attachment device 800 and the cap removal tool prior to insertion. The domed end 804 of the attachment body 802 faces the socket 104 to facilitate insertion of the attachment body 802 into the socket 104. The attachment body 802 includes a circumferential groove formed on an exterior surface thereof configured to be engaged by the cleat carried by the tab 108 when the keyring attachment device 800 is received within the socket 104. The circumferential groove on the attachment body 802 is similar in configuration to the circumferential groove 204 on the valve cap 200, allowing the keyring attachment device 800 to be retained within the socket 104 in the same manner as a valve cap.

In use, the keyring attachment device 800 is inserted into the socket 104 such that the domed end 804 enters the socket 104 first and causes the tab 108 to deflect outwardly as the attachment body 802 passes thereby, with the cleat carried by the tab 108 subsequently snapping inwardly into the circumferential groove on the attachment body 802 to retain the keyring attachment device 800 within the socket 104.

A user may detach the cap removal tool from the keyring attachment device 800 by withdrawing the tool such that the cleat disengages from the circumferential groove on the attachment body 802. After servicing tires, the user reinserts the keyring attachment device 800 into the socket 104, where the cleat re-engages the circumferential groove to secure the cap removal tool to the keyring 810 for convenient carrying. The arrangement provides constant visibility of the tool on the keyring 810, serving as a reminder to check tire pressure or valve cap tightness. This configuration may be particularly useful for commercial truck drivers or other users who frequently need the tool readily accessible.

Based upon the foregoing disclosure, it is seen that the present disclosure provides a keyring attachment device 800 that may allow a user to conveniently carry a cap removal tool on a keyring. The attachment body 802 with circumferential groove may engage the cleat within the socket 104 to retain the keyring attachment device 800 within the socket 104. The spade-like protrusion 806 with through hole 808 may receive a keyring 810 for attachment to a user's keys or other items. The keyring attachment device 800 may be detached from the tool for tire servicing and reattached when finished, providing convenient storage and constant visibility of the tool.

In some cases, a tool body may have a barrel-shaped body with a central bulge to prevent finger slippage during rotation. The central bulge may provide a natural gripping surface that resists axial movement of the user's hand along the tool body during threading and unthreading operations.

In some cases, a tool body may incorporate longitudinal flutes or knurling patterns on an outer surface of the tool body to enhance grip. Longitudinal flutes may provide channels that increase friction between the tool body and a user's fingers. Knurling patterns may provide a textured surface that enhances grip, particularly when a user is wearing gloves.

In some cases, a tool body may have a contoured hourglass shape to provide natural finger positioning. The hourglass shape may include a narrowed central region that accommodates a user's fingers and widened end regions that prevent the hand from sliding off the tool body during use.

In some cases, a tool body may incorporate rubberized overmold sections to improve grip and thermal insulation during cold weather use. The rubberized overmold sections may be disposed on portions of the tool body where a user's hand contacts the tool body during operation. The rubberized overmold sections may provide thermal insulation that reduces heat transfer between the tool body and the user's hand when the tool body is cold.

In some cases, a tool body may incorporate finger indentations or recesses sized for typical adult finger placement. The finger indentations may be positioned along the tool body at locations corresponding to natural finger positions when gripping the tool body. The finger indentations may provide a secure grip that resists rotation of the tool body within the user's hand.

In some cases, a tool body may be manufactured from fiberglass-reinforced plastic to provide enhanced strength while maintaining electrical insulation properties. Fiberglass-reinforced plastic may provide a lightweight construction with increased tensile strength compared to unreinforced plastic materials.

In some cases, a tool body may be manufactured from aluminum to provide a premium feel and enhanced durability while remaining lightweight. Aluminum construction may provide corrosion resistance and may allow for anodized surface finishes in various colors.

In some cases, a tool body may be manufactured from stainless steel to provide maximum durability for professional use environments. Stainless steel construction may provide resistance to corrosion, impact damage, and wear from repeated use.

In some cases, a tool body may have overmolded construction with a rigid core and a soft outer grip to combine structural integrity with ergonomic comfort. The rigid core may be manufactured from a plastic or metal material to provide structural support, and the soft outer grip may be manufactured from a thermoplastic elastomer or rubber material to provide a comfortable gripping surface.

In some cases, a cap removal tool may incorporate a belt clip molded into or attached to the tool body to allow hands-free carrying. The belt clip may be configured to engage a belt, pocket edge, or other garment feature to secure the cap removal tool to a user's clothing.

In some cases, a cap removal tool may have a magnetic strip on the tool body to allow attachment to metal surfaces for storage. The magnetic strip may be disposed on a flat surface of the tool body and may provide sufficient magnetic force to retain the cap removal tool on a vertical metal surface such as a toolbox or workbench.

In some cases, a cap removal tool may have a protective cap or cover for a socket end to prevent debris accumulation during storage. The protective cap or cover may be removably attached to the socket end and may seal the socket opening to prevent entry of dust, dirt, and other contaminants.

In some cases, a cap removal tool may include a carrying case configured to hold the tool, spare caps, and a pressure gauge for organized storage and transport. The carrying case may include compartments or recesses sized to receive the cap removal tool and accessories, and may include a closure mechanism to secure the contents during transport.

In some cases, a cap removal tool may include a hole in an end of the tool body for attachment of a wrist tether. The hole may be sized to receive a lanyard or cord, and the wrist tether may prevent the cap removal tool from being dropped or lost during tire servicing operations.

Based upon the foregoing disclosure, it is seen that the present disclosure provides a tool body that may be configured with various ergonomic features to enhance grip and comfort during tire servicing operations. The barrel-shaped body, knurling patterns, hourglass shape, rubberized overmold sections, and finger indentations may provide secure gripping surfaces that accommodate different user preferences and operating conditions. The material options including fiberglass-reinforced plastic, aluminum, stainless steel, and overmolded construction may provide different combinations of strength, weight, durability, and comfort. The storage and carrying features including belt clips, magnetic strips, protective covers, carrying cases, and wrist tether holes may facilitate convenient storage and transport of the cap removal tool.

In some cases, a valve cap may be manufactured from polycarbonate to provide enhanced impact resistance and optical clarity if colored or transparent caps are desired. Polycarbonate construction may allow for valve caps that are visually distinguishable while maintaining durability during handling and tire servicing operations.

In some cases, a valve cap may be manufactured from glass-filled nylon to provide increased stiffness and dimensional stability across temperature extremes. Glass-filled nylon construction may maintain consistent thread engagement and retention characteristics when exposed to varying environmental conditions.

In some cases, a valve cap may be manufactured from thermoplastic elastomer to provide enhanced sealing against valve stem threads. Thermoplastic elastomer construction may conform to valve stem thread profiles to reduce moisture and debris intrusion.

In some cases, a valve cap may be manufactured from UV-stabilized materials to resist degradation from prolonged sun exposure. UV-stabilized materials may maintain structural integrity and color stability when valve caps are exposed to direct sunlight over extended periods.

In some cases, a valve cap may incorporate antimicrobial additives into the cap material to inhibit bacterial growth on frequently handled surfaces. Antimicrobial additives may reduce the accumulation of bacteria on valve cap surfaces that are contacted by multiple users during tire servicing operations.

In some cases, a valve cap may incorporate color-coding in different colors to allow visual differentiation between front and rear tires or between different vehicles. Color-coded valve caps may allow a user to identify tire positions or vehicle assignments without removing the valve caps for inspection.

In some cases, a valve cap may have embossed or debossed alphanumeric characters to provide permanent identification. Embossed or debossed characters may be formed in a cap body during manufacturing to indicate tire position, vehicle identification, or pressure specifications.

In some cases, a valve cap may have a writable surface area that accepts permanent marker to allow user customization. A writable surface area may be provided on a domed end or exterior surface of a cap body to receive handwritten notations.

In some cases, a valve cap may have RFID tags embedded to enable electronic identification and tracking. Embedded RFID tags may store tire information, maintenance records, or vehicle identification data that can be read by an RFID reader during tire servicing operations.

In some cases, a valve cap may incorporate an O-ring seated in a groove on an inner surface of internal threads to provide a secondary seal against moisture and debris intrusion. The O-ring may compress against a valve stem when the valve cap is threaded onto the valve stem to form a seal that supplements the thread engagement.

In some cases, a valve cap may have a conical sealing surface on an inner end that mates with a valve stem tip to provide positive sealing. The conical sealing surface may contact the valve stem tip when the valve cap is fully threaded onto the valve stem to create a seal independent of the thread engagement.

In some cases, a valve cap may have a flexible sealing lip molded into a cap opening to wipe debris from valve stem threads during installation. The flexible sealing lip may contact the valve stem threads as the valve cap is threaded onto the valve stem to remove dust, dirt, and other contaminants from the thread surfaces.

In some cases, a valve cap may include a protrusion with a hole for attachment to a key ring. The protrusion may extend from a domed end or exterior surface of a cap body and may be sized to receive a split ring or lanyard for attachment to a key ring, tool, or other carrying device.

In some cases, a valve cap may be manufactured with a built-in ferromagnetic insert so that the valve cap can be held inside a magnetized tool socket. The ferromagnetic insert may be embedded within a cap body during manufacturing and may be attracted to a magnetic field generated by a magnetized socket of a cap removal tool.

In some cases, a cap removal tool may include a magnetized socket to retain a magnetic valve cap until the valve cap is replaced on a valve stem. The magnetized socket may generate a magnetic field that attracts a ferromagnetic insert within a valve cap to retain the valve cap within the socket during tire servicing operations. The magnetic retention may supplement or replace the mechanical retention provided by a deflectable tab and cleat engagement with a circumferential groove.

Based upon the foregoing disclosure, it is seen that the present disclosure provides valve cap material options and features that may enhance durability, identification, sealing, and retention during tire servicing operations. The material options including polycarbonate, glass-filled nylon, thermoplastic elastomer, UV-stabilized materials, and antimicrobial additives may provide different combinations of impact resistance, dimensional stability, sealing performance, environmental resistance, and hygiene characteristics. The identification features including color-coding, embossed characters, writable surfaces, and RFID tags may allow visual or electronic differentiation and tracking of valve caps. The sealing enhancements including O-ring seals, conical sealing surfaces, and flexible sealing lips may reduce moisture and debris intrusion at the valve stem. The keyring attachment features and ferromagnetic insert options with magnetized sockets may provide additional retention and carrying options for valve caps and cap removal tools.

In some cases, a cap removal tool may be configured as an electric tool with a built-in electric motor for powered rotation. The electric motor may be housed within a tool body and may be coupled to a socket to provide rotational torque for threading and unthreading valve caps relative to tire valve stems. The electric motor may be actuated by a trigger, button, or switch disposed on the tool body.

In some cases, a cap removal tool may be cordless and rechargeable for convenient use when checking pressure on vehicles with many tires such as 18-wheelers. A cordless rechargeable configuration may allow a user to service multiple tires in sequence without the constraint of a power cord.

In some cases, a cap removal tool may be powered by a removable battery pack that can be charged separately to allow continuous use with spare batteries. The removable battery pack may be detachable from the tool body and may be replaced with a fully charged spare battery pack when the installed battery pack is depleted. A user may maintain multiple battery packs in rotation to provide uninterrupted operation during extended tire servicing sessions.

In some cases, a cap removal tool may incorporate solar cells integrated into a tool body to provide trickle charging during storage. The solar cells may be disposed on an exterior surface of the tool body and may convert ambient light into electrical energy to charge an internal battery. Solar cell integration may maintain battery charge during periods of non-use when the cap removal tool is stored in a location with exposure to natural or artificial light.

In some cases, a cap removal tool may incorporate a hand-crank dynamo mechanism to provide emergency power when batteries are depleted. The hand-crank dynamo mechanism may include a rotatable crank handle coupled to a generator that converts mechanical rotation into electrical energy. A user may rotate the crank handle to generate sufficient power for immediate use of the cap removal tool when other power sources are unavailable.

In some cases, a cap removal tool may have inductive charging capability to allow the tool to be charged by placing the tool on a charging pad without connecting cables. The inductive charging capability may include a receiving coil disposed within the tool body that receives electromagnetic energy from a transmitting coil in the charging pad. Inductive charging may eliminate wear on charging ports and may allow charging without removing protective covers or caps from the tool body.

In some cases, a socket may be configured with interchangeable socket inserts to allow the same tool body to work with Schrader, Presta, and Dunlop valve types. The interchangeable socket inserts may be removably received within a socket housing and may be swapped by a user to match a valve cap configuration for a particular tire valve type. Each socket insert may include a deflectable tab carrying a cleat sized and positioned to engage a circumferential groove on a corresponding valve cap type.

In some cases, a socket may have a universal socket geometry that accommodates multiple valve cap sizes to eliminate the need for multiple tools. The universal socket geometry may include a tapered interior profile or stepped interior surfaces that engage valve caps of different diameters. A deflectable tab within the universal socket may be configured with sufficient flexibility to engage circumferential grooves at different radial positions corresponding to different valve cap sizes.

In some cases, a socket may include adapter sleeves that fit over a standard socket to extend compatibility to larger industrial valve caps. The adapter sleeves may be removably attached to an exterior of the socket and may provide an enlarged socket opening and interior cavity sized to receive industrial valve caps. The adapter sleeves may include deflectable tabs and cleats configured to engage circumferential grooves on industrial valve caps.

In some cases, a cap removal tool or a valve cap may incorporate thermochromic material that changes color based on temperature to provide visual indication of tire temperature. The thermochromic material may be disposed on an exterior surface of the tool body or on an exterior surface of a cap body. The thermochromic material may transition between different colors at predetermined temperature thresholds to indicate whether a tire is at ambient temperature, at an elevated operating temperature, or at a temperature that may warrant attention. A user may observe the color of the thermochromic material to assess tire temperature without requiring a separate temperature measurement device.

Based upon the foregoing disclosure, it is seen that the present disclosure provides power source options and multi-valve compatibility features that may enhance the versatility and convenience of a cap removal tool. The electric motor configuration with cordless rechargeable operation may allow powered rotation for efficient tire servicing on vehicles with multiple tires. The removable battery packs, solar cell charging, hand-crank dynamo mechanisms, and inductive charging capability may provide multiple options for maintaining power availability. The interchangeable socket inserts, universal socket geometry, and adapter sleeves may allow a single tool body to accommodate different valve cap types and sizes. The thermochromic material may provide visual temperature indication without requiring separate measurement equipment.

A method of removing a valve cap from a tire valve stem may include positioning a socket of a valve cap tool over a valve cap threaded onto a tire valve stem. As described above, the socket may include a deflectable tab carrying a cleat on an inner surface of the tab. The user may align the socket with the valve cap such that the valve cap enters the socket through a socket opening.

The method may further include inserting the valve cap into the socket such that the cleat engages a circumferential groove on an exterior surface of the valve cap to retain the valve cap within the socket. As the valve cap enters the socket, the deflectable tab may deflect outwardly to permit passage of the valve cap body past the cleat. Once the circumferential groove on the valve cap reaches the position of the cleat, the deflectable tab may return inwardly and the cleat may snap into the circumferential groove. The engagement between the cleat and the circumferential groove may retain the valve cap within the socket during subsequent operations.

The method may further include rotating the valve cap tool to unthread the valve cap from the tire valve stem while the valve cap is retained within the socket. The user may grasp a grip section of the valve cap tool and rotate the valve cap tool in a direction that unthreads the valve cap from the tire valve stem. The socket may have a polygonal interior cross-section that engages a corresponding polygonal exterior cross-section of the valve cap to transmit rotational torque from the valve cap tool to the valve cap. The retention of the valve cap within the socket by the cleat and circumferential groove engagement may prevent the valve cap from being dropped or misplaced during the unthreading operation.

In some cases, the method may further include depressing a valve core of the tire valve stem with a deflator nub projecting from an exterior surface of the valve cap tool to release air from a tire. As described above, the deflator nub may project from an exterior surface of the tool body adjacent the socket. After removing the valve cap from the tire valve stem, the user may position the deflator nub against the valve core and apply pressure to depress the valve core. Depressing the valve core may open the valve and allow pressurized air to escape from the tire. The user may release pressure on the deflator nub to allow the valve core to return to a closed position and stop the release of air from the tire.

In some cases, the method may further include reinstalling the valve cap onto the tire valve stem. The method may include positioning the socket over the tire valve stem with the valve cap retained therein. The user may align the threaded end of the valve cap with the external threads of the tire valve stem. The method may further include rotating the valve cap tool in an opposite direction to thread the valve cap onto the tire valve stem. The user may rotate the valve cap tool in a direction opposite to the direction used during the unthreading operation to advance the valve cap onto the tire valve stem. The socket may transmit rotational torque to the valve cap through engagement between the polygonal interior cross-section of the socket and the polygonal exterior cross-section of the valve cap. The user may continue rotating the valve cap tool until the valve cap is threaded onto the tire valve stem to a desired tightness.

In some cases, the user may release the valve cap from the socket after threading the valve cap onto the tire valve stem. The user may withdraw the valve cap tool from the valve cap, causing the deflectable tab to deflect outwardly as the cleat disengages from the circumferential groove. In some cases, the user may actuate a cap ejector to dislodge the valve cap from the socket.

In some cases, the method may be performed using a powered driver coupled to a socket bit tool. The user may insert a hex shank of the socket bit tool into a chuck of the powered driver. The user may position the socket over the valve cap and actuate the powered driver to rotate the socket bit tool. The powered driver may provide rotational torque to unthread or thread the valve cap relative to the tire valve stem.

Based upon the foregoing disclosure, it is seen that the present disclosure provides a method of removing a valve cap from a tire valve stem that may reduce the likelihood of dropping or misplacing the valve cap during tire servicing operations. The engagement between the cleat and the circumferential groove may retain the valve cap within the socket during removal and reinstallation. The deflator nub may allow a user to release air from a tire without requiring a separate tool. The method may allow a user to remove, retain, and reinstall a valve cap without direct finger contact with the valve cap, which may be beneficial when valve caps are soiled or when a user is wearing gloves.

Based upon the foregoing disclosure, it is seen that the present disclosure provides a valve cap tool and valve cap tool system that may facilitate tire pressure maintenance and reduce the likelihood of losing or misplacing valve caps during tire servicing operations. The retention mechanism, including a deflectable tab carrying a cleat configured to engage a circumferential groove on a valve cap, may securely retain the valve cap within a socket during removal from and replacement onto a tire valve stem. The snap-fit engagement between the cleat and the circumferential groove may resist inadvertent dislodgement of the valve cap while permitting intentional removal when desired.

The valve cap tool may allow a user to remove and replace valve caps without direct finger contact with the valve cap. Avoiding direct finger contact may be beneficial when valve caps are soiled with road grime, brake dust, or other contaminants that would otherwise transfer to the user's fingers. The valve cap tool may also facilitate tire servicing operations when a user is wearing gloves, such as during cold weather conditions, by providing a gripping surface and retention mechanism that accommodate gloved operation.

The polygonal interior cross-section of the socket may engage a corresponding polygonal exterior cross-section of the valve cap to transmit rotational torque during threading and unthreading operations. The transmission of rotational torque through the socket may allow a user to tighten valve caps securely onto tire valve stems, which may reduce the likelihood of valve caps loosening due to road vibration and eventually falling off the valve stem.

The integrated features of the valve cap tool may improve convenience and efficiency during tire pressure maintenance. A deflator nub projecting from an exterior surface of the tool body adjacent the socket may allow a user to release air from a tire without requiring a separate tool. A pressure gauge coupled to the tool body may allow a user to measure tire pressure and remove or replace valve caps using a single handheld device, which may streamline tire servicing operations and reduce the number of separate tools a user carries. A flashlight body coupled to the tool body with a light source disposed thereon may provide illumination during tire servicing operations in dark or low-light conditions, which may improve visibility and convenience when servicing tires at night or in poorly lit areas.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. A valve cap tool, comprising:
a tool body;
a socket defined at one end of the tool body, the socket configured to receive a valve cap therein;
a deflectable tab disposed within the socket; and
a cleat disposed on an inner surface of the tab, the cleat configured to engage a circumferential groove on an exterior surface of the valve cap to retain the valve cap within the socket.

2. The valve cap tool of claim 1, wherein the tab is one of a pair of opposed tabs formed along a wall of the socket, each tab of the pair carrying a respective cleat on an inner surface thereof.

3. The valve cap tool of claim 1, wherein the tab is integrally formed along a wall of the socket.

4. The valve cap tool of claim 1, further comprising a spring clip disposed within the socket, wherein the tab is a clip tab of the spring clip, and wherein the cleat is a clip cleat carried by the clip tab, and wherein the socket includes a retention aperture configured to receive and secure the spring clip.

5. The valve cap tool of claim 1, further comprising a deflator nub projecting from an exterior surface of the tool body adjacent the socket, the deflator nub configured to depress a valve core of a tire valve.

6. The valve cap tool of claim 1, further comprising a grip section at an end of the tool body opposite the socket.

7. The valve cap tool of claim 1, wherein the socket has a polygonal interior cross-section configured to transmit rotational torque to the valve cap.

8. The valve cap tool of claim 1, further comprising:
a bore extending through the tool body and communicating with the socket; and
a cap ejector slidably disposed within the bore, the cap ejector movable to dislodge the valve cap from the socket.

9. The valve cap tool of claim 8, further comprising an ejector retention rod extending through the tool body and through a slot in the cap ejector to retain the cap ejector within the tool body while permitting axial movement of the cap ejector.

10. The valve cap tool of claim 1, further comprising a second socket defined at an end of the tool body opposite the socket, the second socket configured to receive a second valve cap therein.

11. The valve cap tool of claim 1, further comprising a hex shank at an end of the tool body opposite the socket, the hex shank configured for engagement by a powered driver.

12. The valve cap tool of claim 10, further comprising a third socket and a fourth socket, wherein the socket, the second socket, the third socket, and the fourth socket are arranged in a cruciform configuration.

13. The valve cap tool of claim 1, further comprising at least one of: a pressure gauge coupled to the tool body, the pressure gauge including a gauge fitting configured to engage a tire valve stem; or a flashlight body coupled to the tool body and a light source disposed on the flashlight body.

14. The valve cap tool of claim 1, further comprising a keyring attachment device configured to be received within the socket, the keyring attachment device including:
an attachment body having an exterior shape configured for retention within the socket;
a protrusion extending from the attachment body; and
a through hole formed in the protrusion and configured to receive a keyring.

15. A valve cap tool system, comprising:
a tool body having a socket at one end thereof, the socket including a deflectable tab carrying a cleat on an inner surface of the tab; and
a valve cap having a cap body with a circumferential groove formed on an exterior surface of the cap body, the circumferential groove configured to be engaged by the cleat when the valve cap is received within the socket to retain the valve cap within the socket.

16. The valve cap tool system of claim 15, wherein the valve cap further comprises:
a domed end closing one axial end of the cap body; and
internal threads formed on an inner surface of the cap body at an end opposite the domed end, the internal threads configured to engage external threads of a tire valve stem.

17. The valve cap tool system of claim 15, wherein the cleat is configured to deflect outwardly upon insertion of the valve cap into the socket and to snap inwardly into the circumferential groove to retain the valve cap.

18. The valve cap tool system of claim 15, further comprising a deflator nub projecting from an exterior surface of the tool body adjacent the socket, the deflator nub configured to depress a valve core of a tire valve.

19. The valve cap tool system of claim 15, wherein the socket has a polygonal interior cross-section and the cap body has a corresponding polygonal exterior cross-section to provide rotational engagement therebetween.

20. The valve cap tool system of claim 16, wherein the valve cap further comprises:
a cap LED disposed within the cap body; and
a battery disposed within the cap body to power the cap LED;
wherein the cap LED is configured to illuminate through the domed end when activated by a wireless signal.

21. A valve cap tool system, comprising:
a tool body having a socket at one end thereof, the socket including a deflectable tab carrying a cleat on an inner surface of the tab; and
a keyring attachment device having an attachment body with a circumferential groove formed on an exterior surface of the attachment body, the circumferential groove configured to be engaged by the cleat when the keyring attachment device is received within the socket to retain the keyring attachment device within the socket;
wherein the keyring attachment device further includes a protrusion extending from the attachment body and a through hole formed in the protrusion configured to receive a keyring.

22. A method of removing a valve cap from a tire valve stem, comprising:
positioning a socket of a valve cap tool over a valve cap threaded onto a tire valve stem, the socket including a deflectable tab carrying a cleat;
inserting the valve cap into the socket such that the cleat engages a circumferential groove on an exterior surface of the valve cap to retain the valve cap within the socket; and
rotating the valve cap tool to unthread the valve cap from the tire valve stem while the valve cap is retained within the socket.

23. The method of claim 22, further comprising depressing a valve core of the tire valve stem with a deflator nub projecting from an exterior surface of the valve cap tool to release air from a tire.

24. The method of claim 22, further comprising:
positioning the socket over the tire valve stem with the valve cap retained therein; and
rotating the valve cap tool in an opposite direction to thread the valve cap onto the tire valve stem.

25. The method of claim 22, further comprising:
prior to positioning the socket over the valve cap, detaching the valve cap tool from a keyring attachment device retained within the socket by withdrawing the valve cap tool such that the cleat disengages from a circumferential groove on the keyring attachment device; and
after rotating the valve cap tool to unthread the valve cap from the tire valve stem, performing tire maintenance and threading the valve cap back onto the tire valve stem, and reinserting the keyring attachment device into the socket such that the cleat engages the circumferential groove on the keyring attachment device to retain the keyring attachment device within the socket.
